(19) United States
(12) Patent Application Publication
(10) Pub. No.: US 2018/0152566 A1
(43) Pub. Date: May 31, 2018

(54) PORTABLE ELECTRONIC DEVICE FOR SCANNING AND EDITING OF DOCUMENTS

(71) Applicant: DEBORAH PEDRAZZI, DELTONA, FL (US)

(72) Inventor: DEBORAH PEDRAZZI, DELTONA, FL (US)

(21) Appl. No.: 15/362,055

(22) Filed: Nov. 28, 2016

(51) Int. Cl. H04N 1/00; H04N 1/44; H04N 1/031

(52) U.S. Cl. CPC H04N 1/0044; H04N 1/00411; H04N 1/00827; H04N 2201/0096; H04N 1/031; H04N 2201/0081; H04N 1/4433

(57) ABSTRACT

A portable electronic device to facilitate scanning of a document and editing of a digital content generated from the scanned document is disclosed. The portable electronic device includes a rectangular scanner frame with scanners, a cover plate mounted within the scanner frame for covering and supporting the document to be scanned and a display unit for conveying a variety of visual information to a user. The display unit is secured to the rectangular scanner frame. The visual information displayed through the display unit includes the digital content scanned by the scanner. The display unit includes a touch screen display for displaying a graphical user interface and to allow the users to edit the digital content displayed on it. The touch screen display of the display unit is capable of recognizing hand written patterns, which can also be incorporated into the digital content displayed on the touch screen display.

### BACKGROUND OF THE EMBODIMENT

### Technical Field of the Embodiment

The present embodiment relates to a portable electronic device including a document scanner and associated computer for scanning and editing documents. More specifically, the present embodiment relates to a portable electronic having document scanning, editing, storing, sharing and handwritten recognition features.

### Description of the Related Art

Document scanners are well known devices that capture and digitize images of documents. In order to use, store and publish documents more efficiently and conveniently, ordinary documents written or printed on paper would be converted to digital data by virtue of optical scanners for the convenience of follow-up application. One of the conventional optical scanners is a flatbed scanner. The flatbed scanner includes a scanning plate for bearing documents and a movable scanning device movably mounted over the scanning plate. In use, the document is put on the scanning plate, and then the movable scanning device is driven to move along the document and scan the document. The flatbed scanner can provide the high quality image, because the document is held still on the scanning plate and the movable scanning device can scan the document smoothly. However, the flatbed scanner has too big size to be portable. Therefore, portable scanners came with the tide of fashion. Some other existing document scanners are generally flat-bed, sheet-fed and hand-held types, and these scanners include a contact-type scanning mechanism comprising a contact glass, a one-dimensional photo-detector array, and a linear array of light-emitting diodes (LEDs) that serves as an illuminating source. The contact-type scanning mechanism reads one line across a page of document at a time. By moving the page of document relatively across this scanning line, the document information can then be captured in a digital format.

There are some prior arts disclosing different methods and apparatus for scanning documents. Of particular note is U.S. Pat. No. 8,786,918 B2 filed by I.R.I.S on Aug. 16, 2012, which discloses a battery-powered portable scanner, having a scanning unit for scanning documents and forming digital representations of the documents. The battery-powered portable scanner includes a processor, communicatively connected to the scanning unit and provided for controlling the scanning operation, at least a first embedded storage capabilities, each of which is communicatively connected to the processor and each of which comprises either an internal memory for internally storing the digital representations or a communication link to an external storage medium for externally storing the digital representations. The processor is provided for enabling autonomous operation without connection to a terminal. The processor may be provided with an embedded routing application, which is provided for routing the digital representations to a predetermined selection among the embedded storage capabilities. However the above prior art do not offer a portable scanner cum computer for scanning, editing, storing, sharing and having handwriting recognition features.

Further U.S. Pat. No. 8,081,849 B2 issued to Martin on Dec. 20, 2011, discloses a handheld optical scanner and/or memory device for capturing images of text from a rendered document. The handheld device include a data storage component, a scanning component configured to capture text from rendered documents, a power storage component, and a universal serial bus port configured to receive and store data from a computing device and transmit data to the computing device. However the above prior art do not offer a portable scanner cum fully functional computer unit for scanning, editing, storing, sharing and having handwriting recognition features.

Another prior art U.S. Pat. No. 8,767,269 B2 issued to Sunwell Concert on Jul. 1, 2014, discloses a portable document scanner that records both image and voice information. The portable document scanner includes a digital camera module configured to capture document images, and a laser frame generator configured to project a visible beam of light forming a laser frame to indicate the corresponding field of view of the optical lens for framing a document to be captured. A light source generated by a laser diode is shaped by passing through a collimating optical element and a diffractive optical element which is configured to produce a visible laser frame for framing a document to be captured. The captured data is then stored in an internal memory of the scanner. A data connector is permanently attached to the scanner body, which is used to connect the scanner directly into a receptacle on an external device for accessing data.

Hence, it can be seen that there is a need for a simple, compact lightweight portable scanner and computer unit for scanning, editing, storing, sharing digital documents. The needed device would be able to recognize handwritings to edit the digital documents and would allow the users including students to easily interact with the digital documents. Moreover the needed device would include multiple scanners to directly scan both documents and books.

### SUMMARY OF THE INVENTION

The present invention relates to a portable electronic device capable of scanning and converting a document into a digital document or a digital content. The portable electronic device enables a user to edit the digital contents of the scanned document, store the digital content, edit the digital content, display the digital content and transfer the digital content obtained from the scanned document. The present portable electronic device includes a scanner portion having a substantially rectangular scanner frame with a number of scanners for scanning one or more documents, a cover plate mounted within the scanner frame for covering and supporting the document to be scanned by the scanner and a tablet portion having a display unit to display the visual information including information related to the scanned document to the user. The display unit is secured to the rectangular scanner frame. The display unit displays the visual information including the digital content scanned by the scanner portion of the portable electronic device.

The portable electronic device can be used to scan documents and books and store the digital contents of the scanned document in a storage unit of the tablet portion of the portable electronic device. The stored document is in digital format, which can be retrieved at anytime from the tablet portion of the portable electronic device for reading, editing and sharing purposes. Further the display unit of the tablet portion is a touch screen display, which is capable of recognizing a plurality of hand written patterns or handwritings on the touch screen display. The users can first scan the documents using the scanning portion of the portable electronic device and then the digital content displayed on the touch screen display can be edited by incorporating handwritings and hand written patterns.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a block diagram showing the main components of the portable electronic device, according to a preferred embodiment of the present invention;

FIG. 2 shows a scanner portion of the present portable electronic device, according to a preferred embodiment of the present invention;

FIG. 3 shows a perspective view of the tablet portion of the present portable electronic device; and

FIG. 4 shows a perspective view of the scanner portion of the present portable electronic device.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

The various electronic devices, which are herein incorporated by reference for their supportive teachings, that may use at least one physical user interface device that may be connected to the electronic device provided include, but are not limited to:

US patents involved in touch-pads, such as those described in (but not limited to): (1) U.S. patent application No. application Ser. No. 10/722,948 (“Touch pad for handheld device”, filed Nov. 25, 2003); (2) U.S. patent application No. application Ser. No. 10/188,182 (“Touch pad for handheld device”, filed Mar. 21, 2006); (3) U.S. patent application Ser. No. 08/210,610 (“Computer system with touchpad support in operating system”, filed Mar. 18, 1994); (4) U.S. patent application No. 643,256 (“Movable touch pad with added functionality”, filed Ser. No. 10/643,256).

US patents involved in touch screens such as those described in (but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005; and (9) U.S. patent application Ser. No. 11/367,749, “Multi-Functional Hand-Held Device,” filed on Mar. 3, 2006.

US patents involving click wheels, such as those described in U.S. patent application Ser. No. 11/549,619 “Method, device, and graphical user interface for dialing with a click wheel” filed on Oct. 13, 2006.

US patents involving keyboards, such as those mentioned in (but not limited to) U.S. patent application Ser. No. 07/711,760 (“Ergonomic keyboard input device”, filed on Jun. 6, 1991).

US patents involving mice, such as those described in (but not limited to) (1) Application Ser. No. 09/167,314 (“Computer mouse with enhance control button(s)”, filed on Oct. 6, 1998); and (2) Application Ser. No. 08/288,945 (“Roller mouse for implementing scrolling in windows applications”, filed on Aug. 10, 1994.

US patents involving gesture recognition means, such as those described in (but not limited to) (1) European Patent application publication number: EP2482176 A2 (“Multi-input gesture control for a display screen”, filed on Nov. 4, 2011), and (2) U.S. patent application with publication number 20120317511 A1 (“DISPLAY WITH BUILT IN 3D SENSING CAPABILITY AND GESTURE CONTROL OF TV”, filed on Aug. 21, 2012).

Display means used by these devices may use LCD (liquid crystal display) technology, LED (Light Emitting Diode) technology, CRT (Cathode Ray Tube) technology, or LPD (Light Emitting Polymer) technology, or any other display technologies. Various realizations of graphics display circuitry that implement a Graphics Processing Unit (GPU) are used to achieve video interface between user and these electronic devices.

The present invention may be implemented on applications that run on a single or variety of operating system platforms, including but not limited to OS X, WINDOWS, UNIX, IOS, ANDROID, SYMBIAN, LINUX, or embedded operating systems, such as VxWorks.

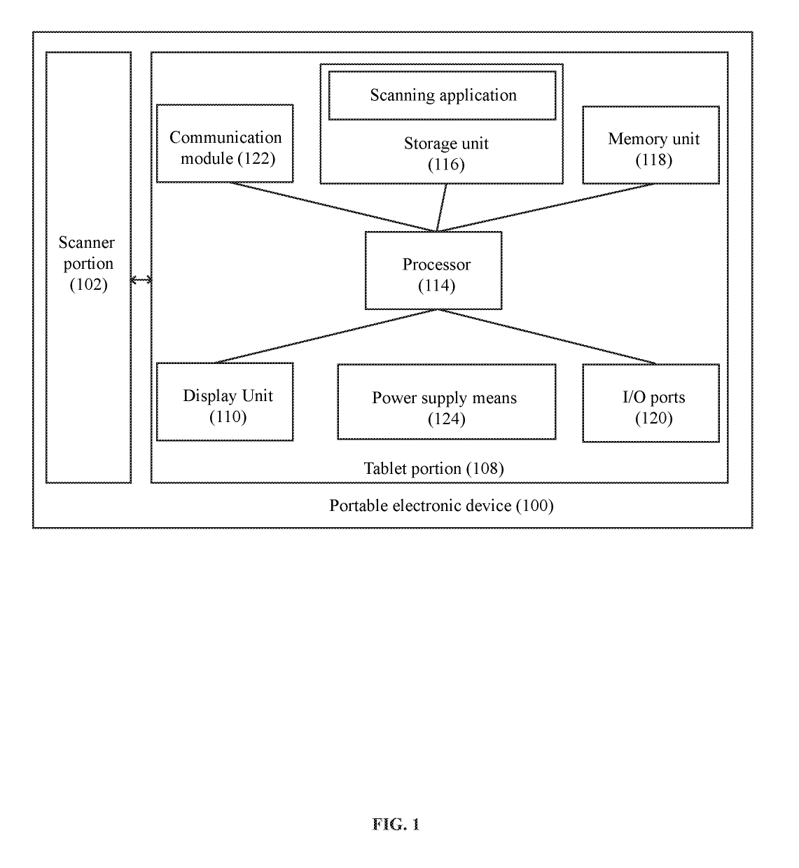

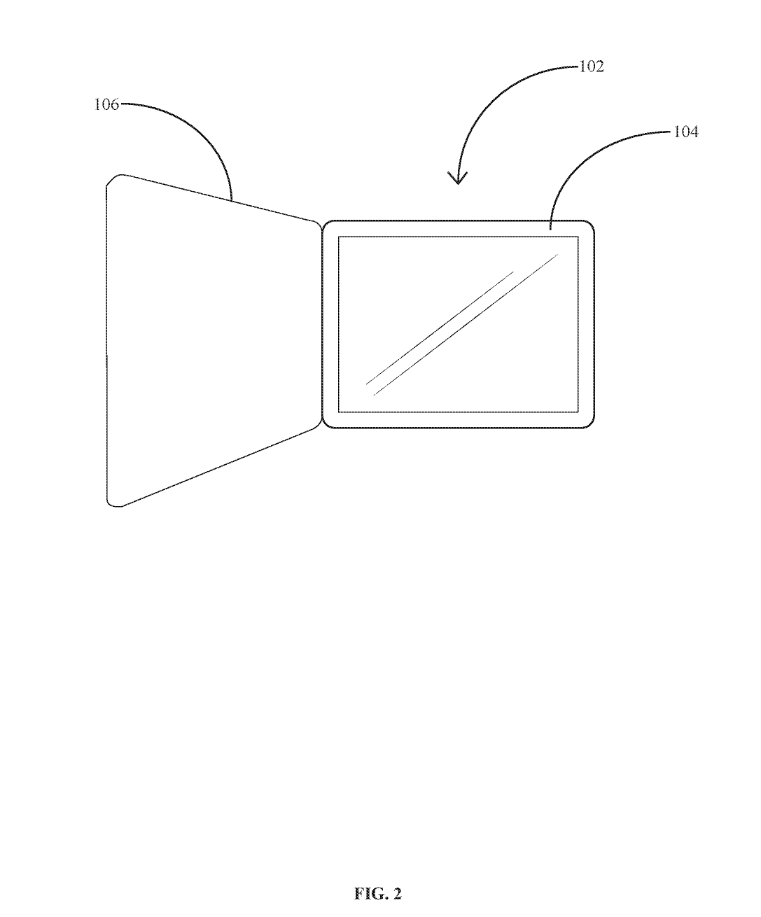

Referring to FIG. 1, there is illustrated a schematic illustration of one embodiment of the invention, and in further reference to FIGS. 2, 3 and 4. Specifically, there is a portable electronic device 100, including a tablet portion 108 and a scanner portion 102. The tablet portion 108 may include a power supply means 124, and a display unit 110, and I/O ports 120 that are coupled to the processor 114 as illustrated. The processor 114 may be coupled to a storage unit 116 (illustrating a scanned data application section), a memory unit 118, and a communication module 122.

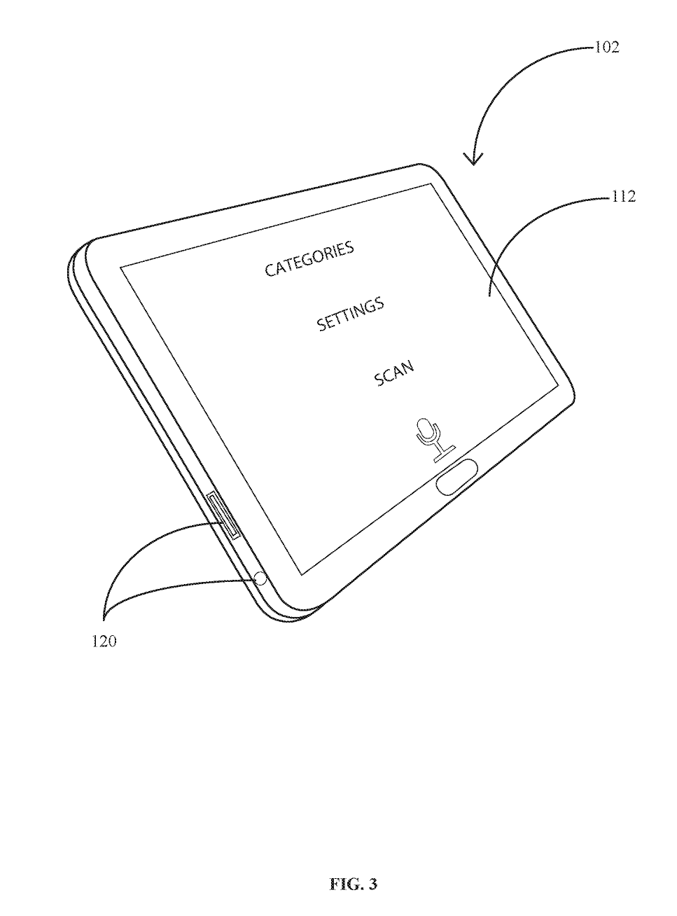

FIGS. 2, 3 and 4 shows an alternative embodiment of illustrating only the scanner portion 102 in FIG. 2, and the table portion 108 in FIG. 3, dof the present portable electronic device 100 according to a preferred embodiment of the present invention. The present portable electronic device 100 includes a scanner portion 102 having a substantially rectangular scanner frame 104 with a number of scanners for scanning one or more documents, a cover plate 106 mounted within the scanner frame 104 for covering and supporting the document to be scanned by the scanner 102 and a tablet portion 108 having a display unit 112 to display the visual information that was scanned. The display unit 112 is secured to the rectangular scanner frame 104 and the display unit 110 displays the visual information including the digital content scanned by the scanner portion 102 of the portable electronic device 100.

In an alternative embodiment, the present portable electronic device 100 has the scanner portion 102 on one side, and the tablet portion 108 on the other side of the device 100, as specifically illustrated in FIG. 3.

In some other embodiment, the present portable electronic device 100 has the scanner portion and the tablet portion connected using a swivel joint or an adjustable joint that allows the user to perform the scanning of the document and view the digital content of the scanned document at the same time. The swivel joint allows the tablet portion of the portable electronic device 100 to make an almost 360 degree rotation about the joint. This enables the users to conveniently place the scanner portion 102 of the present portable electronic device 100 for scanning the document and view the digitally converted contents of the document on the tablet portion 108. In a yet another embodiment, the present portable electronic device 100 has the tablet portion detachable from the scanner portion. The user can attach the scanner portion 102 and the tablet portion 108 together using a magnetic or other detachable attachment provided with both the scanner portion and the tablet portion. When required, the user can scan documents using the scanner portion 102 of the portable electronic device 100 and can view and edit the digital content in the scanned document on the tablet portion 108 of the portable electronic device 100. The user can also detach the tablet portion 108 from the scanner portion 102 to perform the scanning of the document and editing of the scanned document. The tablet portion 108 and the scanner portion 102 of the portable electronic device 100 may communicate wirelessly when in a separated mode and communicates through a contact provided on either parts when joined together.

The following discussion refers now to both FIGS. 1 and 3. FIG. 3 shows a perspective view of the tablet portion 108 of the present portable electronic device 100. Referring back to FIG. 1, which shows the block diagram showing the different internal hardware components of the tablet portion 108 of the portable electronic device 100. The tablet portion 108 having the display unit 112 that may include a touch screen display, a processor 114 and associated electronic components to process the digital contents of the scanned document and a plurality of inputs 120 from the users received through the touch screen display 112, a storage unit 116 to store the scanned documents and other data, an operating system and associated software for operating the tablet portion 108 and the scanner portion 102 of the portable electronic device 100. The touch screen display 112 includes a graphical user interface (GUI), which provides a plurality of visual information to the users. In certain embodiment, the tablet portion 108 of the portable electronic device 100 has similar components as that of a Smartphone or a portable computer, such as, the processor 114 to process a plurality of data, the storage unit 116 for storing the operating system files and other files associated with installed software including a scanning software associated with the present portable electronic device 100, touch screen display 112 for displaying the digital contents of the scanned document and the graphical user interface of the operating system and other software, a memory unit 118 for temporary storage of data during execution of instructions by the processor 114, and a plurality of input/output ports 120, such as, but not limited to, Universal Serial Bus (USB) ports, headphone jacks, and other ports to operably connect a plurality of external electronic devices with the portable electronic device 100. The portable electronic device 100 further includes a communication module 122 to enable wireless communication with other devices and to connect to the internet over a wireless communication channel such as, but not limited to, WiFi, mobile data communication etc.

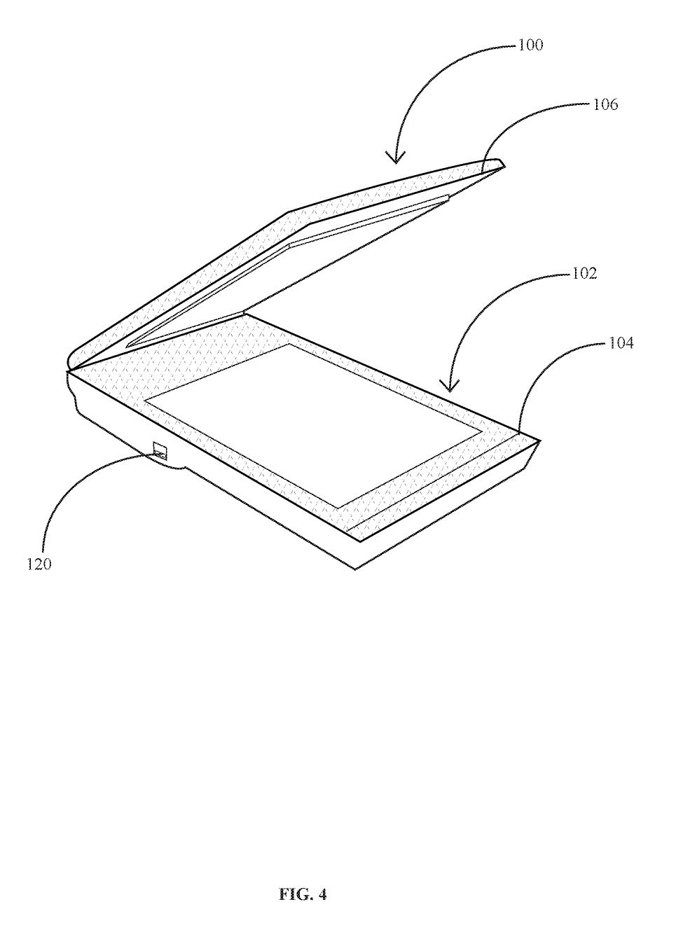

FIG. 4 shows a perspective view of the scanner portion 102 of the present portable electronic device 100. The users can place the documents in the scanner frame 104 and cover using the cover plate 106 and scan the document using a control button provided on the scanner portion 102 of the present portable electronic device 100 or through the graphical user interface displayed on the touch screen display 112 of the tablet portion 108. The tablet portion 108 of the present portable electronic device 100 allows authorized users to browse through the information displayed on the touch screen display 112. The display unit 110 of the tablet portion 108 may use LCD (liquid crystal display) technology, LED (light Emitting Diode) technology, CRT (Cathode ray tube) technology, or LPD (light emitting polymer) technology, or any other display technologies. Various realizations of graphics display circuitry that implement a Graphics Processing Unit (GPU) are used to achieve video interface between user and the portable electronic device 100. The operating system of the portable electronic device 100 may include, but not limited to, OS X, WINDOWS, UNIX, IOS, ANDROID, SYMBIAN, LINUX, or embedded operating systems. The software or applications installed in the portable electronic device 100 are compatible with the particular operating system running the portable electronic device 100. The operating system of the portable electronic device 100 is programmed with an authentication module to provide a controlled access to the portable electronic device 100. The users are provided with unique user credentials such as pin codes, thumbprints, etc., and are prompted to enter the authentication code before operating the portable electronic device 100. The graphical user interface on the touch screen display 112 provides the user with a plurality of input field to input login credentials for authentication of the user. After successful authentication of the user, the graphical user interface on the touch screen display 112 provides the user with an interface and options or tools to edit the digital content displayed on the display unit 110. The scanner portion 102 of the portable electronic device 100 includes a contact image sensor to scan the documents.

In a preferred embodiment, the rectangular scanner frame 104 has dimensions to fit an A4 sized paper for scanning. According to another embodiment, the rectangular scanner frame 104 includes a number of scanners and one of the scanners is adapted to scan a paper or document and another scanner is adapted to scan a book. The scanning potion 102 of the portable electronic device 100 scans the paper. In some embodiments, the scanning potion 102 of the portable electronic device 100 includes a touch screen cover will show icons in different language that will enable a user to choose the scanning options. However, the users can also select the scanning options from the user interface of the scanning software displayed on the touch screen display 112. The documents scanned using the present portable electronic device 100 can be directly converted to corresponding digital content format, which the user can edit or interact with through the touch screen display 112. For example for the subject math, a user will put the paper in the scanning potion 102 and scans the document. Once the paper is scanned, the user can view the corresponding digital content format of the math paper through the touch screen display 112 and can answer the problems on the digital content corresponding to the math paper through the touch screen display 112. As the user writes the on the touch screen display 112, the answers are displayed as cartoons or in different colors whatever the user finds fun to write in. The users can set these options form the user interface of the scanning application running on the portable electronic device 100. The user can first launch the scanning application from the tablet portion 108 and set the options through the user interface of the scanning application displayed on the touch screen display 112. Further the touch screen display 112 can display icons that will show different grade levels and subjects. The students can utilize these options including the icons displayed through the user interface of the scanning application displayed on the touch screen display 112 to make learning fun and easier. A user can pick a grade level and a subject and can scan the paper or book the user studying. The scanned paper or book is then displayed on the touch screen display 112. On the side of the tablet portion 108, the icons are present and the users can chose desired icons while viewing the contents of the scanned paper or book. The colors, cartoons, or pictures even different types of games displayed through the user interface of the touch screen display 112 helps the students and children to perform homework and other studying operations in a fun manner.

The documents or book scanned using the present scanner portion 102 of the portable electronic device 100 is stored in the storage unit 116 of the tablet portion 108 of the portable electronic device 100. The stored document is in digital format, which can be retrieved any time for reading, editing and sharing purposes. Further the touch screen display 112 of the display unit 110 is capable of recognizing a plurality of hand written patterns or handwritings on the touch screen display 112. The users can first scan the documents using the scanning portion 102 of the portable electronic device 100 and then the digital content displayed on the touch screen display 112 can be edited by incorporating handwritings and hand written patterns. This feature is useful for reviewing or commenting documents as the user can directly comment on the digital content corresponding to the scanned document using handwritings or hand written patterns.

The portable electronic device 100 with the touch screen display 112 provided is provided with handwriting recognition to incorporate the hand written pattern into the digital content, which is the scanned copy of the page(s) scanned in the scanners, displayed on the touchscreen display 112 of the portable electronic device 100. The portable electronic device 100 is a computer tablet with a plurality of arrangements for scanning documents. The portable electronic device 100 includes a power supply means 124, which is capable of powering the scanning portion 102 and the tablet portion 108 of the portable electronic device 100. The portable electronic device 100 further includes a power button to control power supply from the power supply means 124. The power supply means 124 is a rechargeable lithium Iron battery incorporated into the portable electronic device 100.

It is noted that the present disclosure relates to a portable electronic device to perform scanning of documents. FIG. 1 is a block diagram showing the main components of the portable electronic device 100. The present portable electronic device 100 is a combination of a portable scanner 102 and a tablet 108. The present portable electronic device 100 can be used to scan and convert the document into a digital document or a digital content. The portable electronic device 100 further enables a user to edit the digital contents of the scanned document, store the digital content, edit the digital content, display the digital content and transfer the digital content obtained from the scanned document. The present portable electronic device 100 is lightweight, compact and can be easily carried by the user. Further the present portable electronic device 100 can be used as a tablet when not used for scanning documents. The present portable electronic device 100 is useful for students and other working professionals to effortlessly scan, edit, store, and transfer documents. The portable electronic device 100 enables the students to work with their homework in a fun and informative manner. The size of the device 100 can be varied depending upon the size of the display screen and the scanner. However, in general, the size of the present portable electronic device 100 is similar to a piece of paper in length and width. Further, in several embodiment, the present portable electronic device 100 has two scanners, one scanner to scan books into the tablet portion associated with the present portable electronic device 100 and other a table scanner portion for scanning paper. The present portable electronic device 100 allows the users to scan books and other documents and store them in digital format in the tablet portion of the present portable electronic device 100 for reading and for other purposes.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

1-14. (canceled)

15. A portable electronic device to facilitate scanning of a document and editing of a digital content, comprising:
a) At least one processor for controlling digital data;
b) a storage media for storing digital data;
c) an operating system for performing operations on the digital data;
d) a scanner device, electrically coupled to the at least one processor, storage media and operating system, designed for scanning a paper that is placed thereon and thereby digitizing data located on the paper;
e) a cover plate, pivotally coupled to one side of the scanner device to enable uncovering and covering of the scanner device before and during a scanning operation respectively; and
f) a display device, electrically coupled to the at least one processor, storage media and operating system, comprised of a touch screen that is coupled to an opposite side of the cover plate, for displaying the digitized data that was scanned by the scanner device; wherein the digital data is editable by a user.

16. The portable electronic device of claim 15, wherein the display device includes a graphical user interface that enables a user to edit the digital data displayed on the display device.

17. The portable electronic device of claim 16, wherein the operating system is programmed with an authentication module to provide controlled access to the portable electronic device.

18. The portable electronic device of claim 17, further comprises hand writing recognition digitization to enable a user to incorporate hand written data into the digitized data displayed on the display device.

19. The portable electronic device of claim 18, further comprises a plurality of ports to connect various external electronic devices.
